(19) United States
(12) Patent Application Publication
(10) Pub. No.: US 2018/0157312 A1
(43) Pub. Date: Jun. 7, 2018

(54) DEVICE WITH AUTOMATIC SHUTDOWN FUNCTION AND METHOD WITH AUTOMATIC SHUTDOWN FUNCTION

(71) Applicants: Fu Tai Hua Industry (Shenzhen) Co., Ltd., Shenzhen (CN); HON HAI PRECISION INDUSTRY CO., LTD., New Taipei (TW)

(72) Inventors: JING-CHUAN YUAN, Shenzhen (CN); GANG-HUA LIU, Shenzhen (CN)

(21) Appl. No.: 15/798,423

(22) Filed: Oct. 31, 2017

(30) Foreign Application Priority Data
Dec. 5, 2016 (CN) 201611101223.2

(51) Int. Cl. G06F 1/32

(52) U.S. Cl. CPC G06F 1/3287; G06F 1/3296

(57) ABSTRACT

A device with function of automatically shutting down when dropped acquires an acceleration value detected by an acceleration sensor, and determines whether the acceleration value is more than a preset acceleration value. A timing unit is controlled to count time when the acceleration value is more than the preset acceleration value, and a travel distance of the device is calculated according to the acceleration value and the time period of the falling. If the travel distance of the device is more than a preset distance, a power management system is controlled to shut down a power supply to the device. A method for such function and system is also provided.

### CROSS-REFERENCE TO RELATED APPLICATIONS

This application claims priority to Chinese Patent Application No. 201611101223.2 filed on Dec. 5, 2016, the contents of which are incorporated by reference herein.

### FIELD

The subject matter herein generally relates to device management, especially relates to an device with automatic shutdown function and method with automatic shutdown function.

### BACKGROUND

When an electronic device, such as a smart phone or a tablet computer, is dropped, some elements of the electronic device can deform and generate short circuit. Also, when the electronic device falls into water and does not shut down, the motherboard of the electronic can be damaged by a short circuit.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a device with an automatic shutdown function.

FIG. 2 is a block diagram of an embodiment of an automatic shutdown system in a device of FIG. 1.

FIG. 3 is a block diagram of another embodiment of the automatic shutdown system of FIG. 2.

FIG. 4 is a schematic diagram of an embodiment of a setting interface in the device of FIG. 1.

FIG. 5 is a flowchart of an embodiment of a method with automatic shutdown function.

FIG. 6 is a flowchart of another embodiment of a method with automatic shutdown function.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” indicates “including, but not necessarily limited to”; it specifically indicates open-ended inclusion or membership in a so-described combination, group, series, and the like.

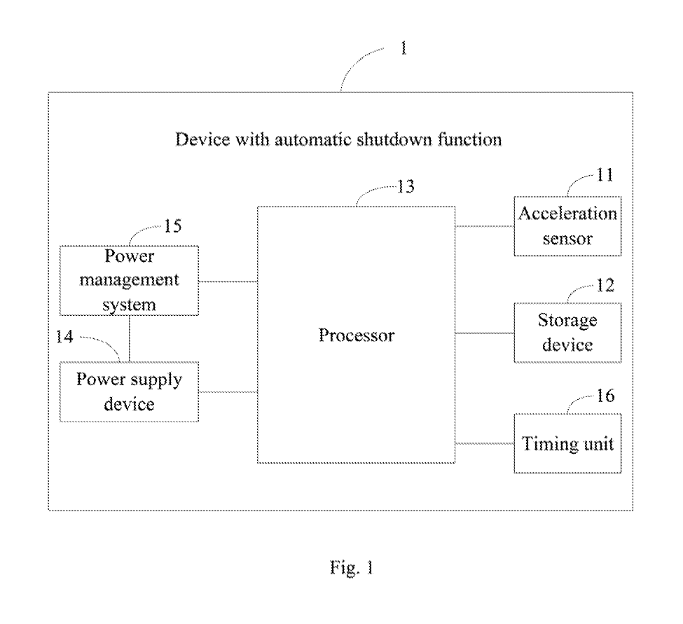

FIG. 1 illustrates a device 1 with automatic shutdown function. The device 1 includes an acceleration sensor 11, a storage device 12, a processor 13, a power supply device 14, and a power management system 15, and a timing unit 16. The acceleration sensor 11 is used to detect an acceleration value of the device 1. The power supply device 14 is managed by the power management system 15 to supply electric energy to the acceleration sensor 11, the storage device 12, the processor 13, and the timing unit 16. In at least one exemplary embodiment, the device 1 can be a smart phone, a tablet computer, or a handheld computer.

The storage device 12 stores data and software program code of the device 1. For example, the storage device 12 stores a preset acceleration value or a preset distance value. In at least one exemplary embodiment, the storage device 12 can include various types of non-transitory computer-readable storage mediums. For example, the storage device 12 can be an internal storage system, such as a flash memory, a random access memory (RAM) for temporary storage of information, and/or a read-only memory (ROM) for permanent storage of information. In another embodiment, the storage device 12 can also be an external storage system, such as a hard disk, a storage card, or a data storage medium. The processor 13 is used to execute software program code or operational data stored in the storage device 13. The processor 13 can be a central processing unit (CPU), a microprocessor, or other data processor chip.

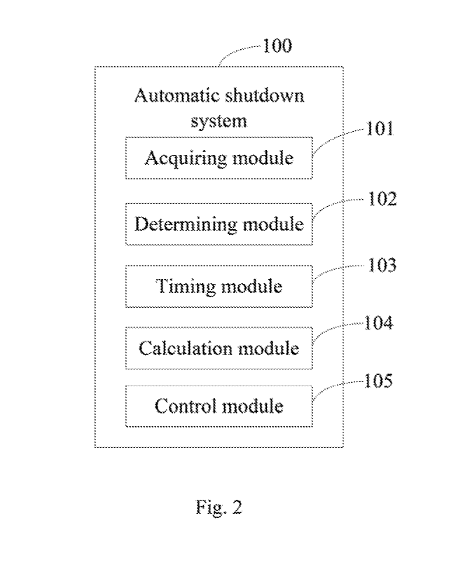

FIG. 2 illustrates an automatic shutdown system 100. The automatic shutdown system 100 is used to acquire the acceleration value of the device 1 detected by the acceleration sensor 11, and control the power management system 15 to shutdown the power supply device 14 to stop supplying power for the device 1. The automatic shutdown system 100 includes, but is not limited to, an acquiring module 11, a determining module 12, a timing module 13, a calculation module 14, and a control module 15. The modules 11-15 of the automatic shutdown system 100 can be collections of software instructions stored in the storage device 12 and executed by the processor 13.

The acquiring module 101 acquires the acceleration value of the device 1 detected by the acceleration sensor 11.

The determining module 102 determines whether the acceleration value of the device 1 is more than the preset acceleration value.

The timing module 103 controls the timing unit 16 to begin counting time when the acceleration value is more than the preset acceleration value.

The calculation module 104 calculates a travel distance of the device 1 according to the acceleration value acquired by the acquiring module 101 and the time detected by the timing module 103.

The determining module 102 further determines whether the travel distance of the automatic shutdown 1 is more than a preset distance.

The control module 105 controls the power management system 15 to shut down the power supply device 14 to stop supplying power for the device 1 when the acceleration value is more than the preset acceleration value.

In at least one exemplary embodiment, the preset acceleration value is 9.8 m/s². The preset distance is 0.2 m. Namely, when the determining module 102 determines that the acceleration value of the device 1 is at least 9.8 m/s², the timing module 102 starts to time. The calculation module 104 calculates the travel distance of the device 1 according to the acceleration value of the device 1 acquired by the acquiring module 101 and the time detected by the timing module 103. When the travel distance is more than 0.2 m at the above acceleration value, the control module 105 controls the power management system 15 to shut down the power supply device 14.

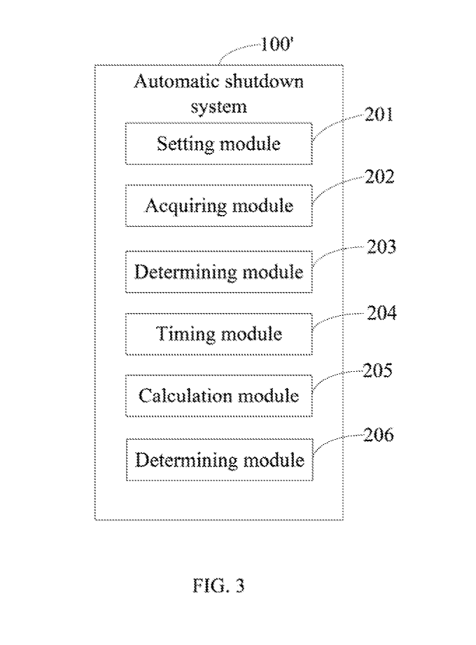

FIG. 3 illustrates another embodiment of the device, namely automatic shutdown system 100′. In one exemplary embodiment, the automatic shutdown system 100′ includes a setting module 201, an acquiring module 202, a determining module 203, a timing module 204, a calculation module 205, and a control module 206.

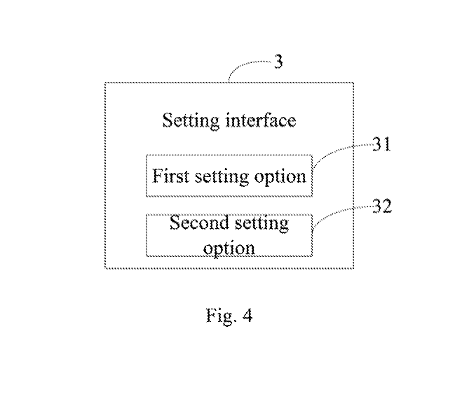

The setting module 201 provides a setting interface 3 for a user to set the preset acceleration value and the preset distance. FIG. 4 illustrates an embodiment of the setting interface 3. The setting interface 3 includes a first setting option 31 and a second setting option 32. The first setting option 31 is used to set the preset acceleration value. The second setting option 32 is used to set the preset distance.

The acquiring module 202 acquires the acceleration value of the device 1 detected by the acceleration sensor 11.

The determining module 203 determines whether the acceleration value of the device 1 is more than the preset acceleration value set by the setting module 201.

The timing module 204 controls the timing unit 16 to begin timing when the acceleration value is more than the preset acceleration value.

The calculation module 205 calculates a travel distance of the device 1 according to the acceleration value acquired by the acquiring module 202 and the time detected by the timing module 204.

The determining module 203 further determines whether the travel distance of the automatic shutdown 1 is more than the preset distance set by the setting module 201.

The control module 105 controls the power management system 15 to shut down the power supply device 14when the acceleration value is more than the preset acceleration value.

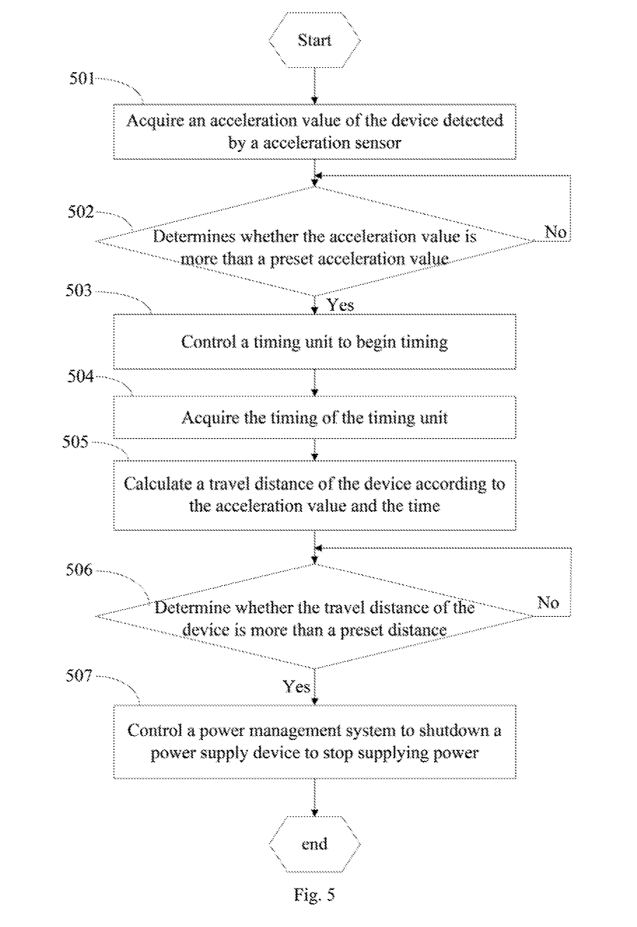

FIG. 5 illustrates a flowchart of an embodiment of a method with automatic shutdown function. The method is applied in a device with automatic shutdown function. The method is provided by way of example, as there are a variety of ways to carry out the method. The method described below can be carried out using the configurations illustrated in FIGS. 1-4, for example, and various elements of these figures are referenced in explaining the example method. Each block shown in FIG. 5 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 501.

At block 501, the device acquires an acceleration value of the device detected by a acceleration sensor.

At block 502, the device determines whether the acceleration value of the device is more than a preset acceleration value. In at least one exemplary embodiment, when the acceleration value of the device is more than the preset acceleration value, the method executes block 503, otherwise, the method executes block 501. In at least one exemplary embodiment, the preset acceleration value is 9.8 m/s².

At block 503, the device controls a timing unit to begin counting time.

At block 504, the device acquires the timing of the timing unit.

At block 505, the device calculates a travel distance of the device according to the acceleration value and the time.

At block 506, the device determines whether the travel distance of the device is more than a preset distance. In at least one exemplary embodiment, when the travel distance of the automatic shutdown is more than the preset distance, the method executes block 507, otherwise, the method executes block 505. In at least one exemplary embodiment, the preset distance can be 0.2 m.

At block 507, the device controls a power management system to shut down a power supply device to stop supplying power.

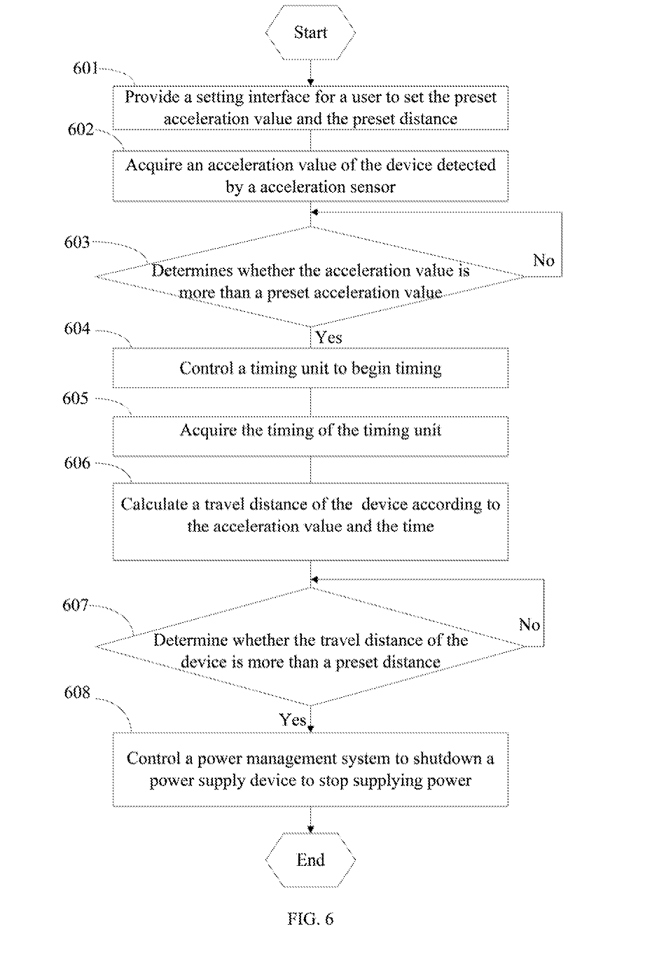

FIG. 6 illustrates a flowchart of another embodiment of a method with automatic shutdown function. The method is applied in a device. Each block shown in FIG. 5 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 601.

At block 601, the device provides a setting interface for a user to set the preset acceleration value and the preset distance. In at least one exemplary embodiment, the setting interface includes a first setting option and a second setting option. The first setting option is used to set the preset acceleration value. The second setting option is used to set the preset distance.

At block 602, the device acquires an acceleration value of the device detected by a acceleration sensor.

At block 603, the device determines whether the acceleration value of the device is more than the preset acceleration value. In at least one exemplary embodiment, when the acceleration value of the device is more than the preset acceleration value, the method executes block 604, otherwise, the method executes block 602.

At block 604, the device controls a timing unit to begin counting time.

At block 605, the device acquires the timing of the timing unit.

At block 606, the device calculates a travel distance of the device according to the acceleration value and the time.

At block 607, the device determines whether the travel distance of the automatic shutdown is more than a preset distance. In at least one exemplary embodiment, when the travel distance of the automatic shutdown is more than the preset distance, the method executes block 507, otherwise, the method executes block 505.

At block 608, the device controls a power management system to shut down a power supply device to stop supplying power.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A device with automatic shutdown function comprising:
an acceleration sensor configured to detect an acceleration value of the device;
a timing unit;
a power management system;
a power supply device configured to be managed by the power management system to supply electric energy to the device; and
a processor coupled to the acceleration sensor, the timing unit and the power management system;
a non-transitory storage medium coupled to the processor and configured to store a plurality of instructions, which cause the processor to control the device to:
acquire the acceleration value of the device detected by the acceleration sensor;
determine whether the acceleration value of the device is more than a preset acceleration value;
control the timing unit to begin timing when the acceleration value is more than the preset acceleration value;
calculate a travel distance of the device according to the acceleration value and the time;
determine whether the travel distance of the device is more than a preset distance; and
control the power management system to shutdown the power supply device to stop supplying power for the device when the acceleration value is more than the preset acceleration value.

2. The device as recited in claim 1, wherein the plurality of instructions is further configured to cause the processor to provide a setting interface for a user to set the preset acceleration value and the preset distance.

3. The device as recited in claim 2, wherein the setting interface comprises a first setting option and a second setting option, the first setting option is configured to set the preset acceleration value, the second setting option is configured to set the preset distance.

4. The device as recited in claim 1, wherein the preset acceleration value is 9.8 m/s².

5. The device as recited in claim 1, wherein the preset distance is 0.2 m.

6. The device as recited in claim 1, wherein the device can be a smart phone, a tablet computer or a handheld computer.

7. A method with automatic shutdown function comprising:
acquiring an acceleration value of a device with automatic shutdown function detected by an acceleration sensor;
determining whether the acceleration value of the device is more than a preset acceleration value;
controlling a timing unit to begin timing when the acceleration value is more than the preset acceleration value;
calculating a travel distance of the device according to the acceleration value and the time;
determining whether the travel distance of the device is more than a preset distance; and
controlling a power management system to shutdown the power supply device to stop supplying power for the device when the acceleration value is more than the preset acceleration value.

8. The method as recited in claim 7, further comprising:
providing a setting interface for a user to set the preset acceleration value and the preset distance.

9. The method as recited in claim 8, wherein the setting interface comprises a first setting option and a second setting option, the first setting option is configured to set the preset acceleration value, the second setting option is configured to set the preset distance.

10. A non-transitory storage medium having stored thereon instructions that, when executed by a processor of a device with automatic shutdown function, causes the processor to execute instructions of an automatic shutdown method, the method comprising:
acquiring an acceleration value of a device with automatic shutdown function detected by an acceleration sensor;
determining whether the acceleration value of the device is more than a preset acceleration value;
controlling a timing unit to begin timing when the acceleration value is more than the preset acceleration value;
calculating a travel distance of the device according to the acceleration value and the time;
determining whether the travel distance of the device is more than a preset distance; and
controlling a power management system to shutdown the power supply device to stop supplying power for the device when the acceleration value is more than the preset acceleration value.

11. The non-transitory storage medium as recited in claim 10, wherein the method is further comprising:
providing a setting interface for a user to set the preset acceleration value and the preset distance.

12. The non-transitory storage medium as recited in claim 11, wherein the setting interface comprises a first setting option and a second setting option, the first setting option is configured to set the preset acceleration value, the second setting option is configured to set the preset distance.
